(19) United States
(12) Patent Application Publication
(10) Pub. No.: US 2021/0289788 A1
(43) Pub. Date: Sep. 23, 2021

(54) HYDROGEN PEROXIDE ANTI-MOLD/BACTERIA/VIRUS SURFACE COATINGS FOR PACKAGING

(71) Applicant: Multi-Color Corporation, Batavia, OH (US)

(72) Inventors: Dimitri Stamatiou, Green Bay, WI (US); Mark A. Shadle, Peachtree City, GA (US)

(21) Appl. No.: 17/204,479

(22) Filed: Mar. 17, 2021

Related U.S. Application Data
(60) Provisional application No. 62/991,197, filed on Mar. 18, 2020.

(51) Int. Cl. A01N 59/00; A01N 25/34; A01N 25/10; A01N 25/28; B65D 81/28; B65D 65/42; B65D 85/34; A23L 3/358

(52) U.S. Cl. CPC A01N 59/00; A01N 25/34; A01N 25/10; A01N 25/28; A23V 2002/00; B65D 65/42; B65D 85/34; A23L 3/358; B65D 81/28

(57) ABSTRACT

Packaging materials or labels that incorporate an anti-mold, anti-bacterial, or anti-virus substance therein or thereon. A container may include a housing defining an interior chamber adapted to receive items, the housing comprising at least one component or having at least one material disposed on at least one component, and an anti-mold, anti-bacterial, or anti-virus substance incorporated in or on the at least one component or in the at least one material. A label may include at least a first label layer and a second label layer, the first label layer being a facestock layer, and the second label layer being chosen from an adhesive, an ink, a varnish, a coating, and a protective layer, and an anti-mold, anti-bacterial, or anti-virus substance incorporated in or on the first label layer or the second label layer.

### CROSS-REFERENCE TO RELATED APPLICATION

This application claims the benefit of the filing date of U.S. Patent Application Ser. No. 62/991,197, filed on Mar. 18, 2020, the disclosure of which is incorporated by reference herein in its entirety.

### FIELD OF THE INVENTION

The present invention relates generally to packaging, and more specifically to packaging that includes surfaces having anti-mold and/or anti-virus properties.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

According to the Center for Disease Control (CDC) hydrogen peroxide kills yeasts, fungi, bacteria, viruses, and mold spores. Current uses of hydrogen peroxide as it relates to the food industry appear to be mainly focused on its incorporation into specific foods as a bleaching agent and/or as a sterilizing agent for packaging materials prior to association with foods themselves.

An example of such a current use can be seen in U.S. Pat. No. 5,328,706. In this patent, an aqueous solution of hydrogen peroxide is integrated into semi-viscous and viscous food products during the processing procedure for reducing microbial activity. It also states that the decomposition of the hydrogen peroxide is regulated by a protein derived enzyme and is monitored to eliminate the presence of peroxide in the finished food product. Thus, the effect of the hydrogen peroxide is temporary and only present during the processing procedure.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

As described above, current uses of hydrogen peroxide (as it relates to the food industry) are mainly focused on incorporation of hydrogen peroxide into specific foods as a bleaching agent and/or as a sterilizing agent for packaging materials prior to association with foods themselves. However, there are currently no uses that allow for a continuous antimicrobial effect over the shelf life of a food product.

One aspect of the present invention, however, incorporates an anti-mold, anti-bacterial, and/or anti-virus substance directly into or onto packaging materials that come into direct contact with the food products themselves. Thus, this aspect may provide a container for packaging items, that container including (1) a housing defining an interior chamber adapted to receive items, the housing comprising at least one component or having at least one material disposed on at least one component; and (2) an anti-mold, anti-bacterial, or anti-virus substance incorporated in or on the at least one component or in the at least one material.

In one embodiment, such an anti-mold, anti-bacterial, and/or anti-virus substance may be food grade hydrogen peroxide. In various embodiments, the incorporation of the hydrogen peroxide directly into the packaging components may occur via incorporation into an existing adhesive, coating, varnish, impregnated into substrate, or surface treatment and could be encapsulated or microencapsulated prior to incorporation. The amount of hydrogen peroxide used may be limited to the amount sufficient for this purpose, and/or may be used at a recommended specific concentration.

Another aspect of the present invention may provide for the use of hydrogen peroxide as an anti-virus agent that can be incorporated into the outside layers of labels and packaging materials. Thus, this aspect may provide a label including (1) at least a first label layer and a second label layer, the first label layer being a facestock layer, and the second label layer being chosen from an adhesive, an ink, a varnish, a coating, and a protective layer; and (2) an anti-mold, anti-bacterial, or anti-virus substance incorporated in or on the first label layer or the second label layer.

In one embodiment, the hydrogen peroxide may be encapsulated (such as in microcapsules) and present on the outside layer of a label or a packaging material. When activated through various mechanisms such as handling and bursting of the microcapsules, the release of the hydrogen peroxide would inhibit, stop, or kill the virus directly on the surfaces. Other embodiments may include microencapsulation of varying size capsules with time release technology, delayed release or controlled release properties. Another version could start the capsule activation with the removal of a top or bottom layer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The accompanying drawings, which are incorporated in and constitute a part of this specification, illustrate embodiments of the invention and, together with the general description of the invention given above and the detailed description of the embodiments given below, serve to explain the principles of the present invention.

FIG. 1A is a perspective view of a container in accordance with principles of the present invention.

FIG. 1B is a close-up view of a section of FIG. 1A, showing a portion of the housing of the container.

FIG. 1C is an alternate embodiment of the housing of FIG. 1B.

FIG. 2 is a cross-sectional view of a label in accordance with principles of the present invention.

3 is a photograph showing an example of fresh fruit in a container with a hydrogen peroxide-modified coating substrate on day 1 of testing.

FIG. 4 is a photograph showing the sample of FIG. 3 on day 4 with little to no noticeable degradation of the fruit.

FIG. 5 is a photograph showing an example of a container with a standard coated substrate (i.e., not including any hydrogen peroxide) on day 1.

FIG. 6 is a photograph showing the container of FIG. 5 on day 4, showing degradation of the fruit and development of mold.

FIGS. 7A and 7B are photographs of a bag embodiment of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, current uses of hydrogen peroxide (as it relates to the food industry) are mainly focused on incorporation of hydrogen peroxide into specific foods as a bleaching agent and/or as a sterilizing agent for packaging materials prior to association with foods themselves. However, there are currently no uses that allow for a continuous antimicrobial effect over the shelf life of a food product.

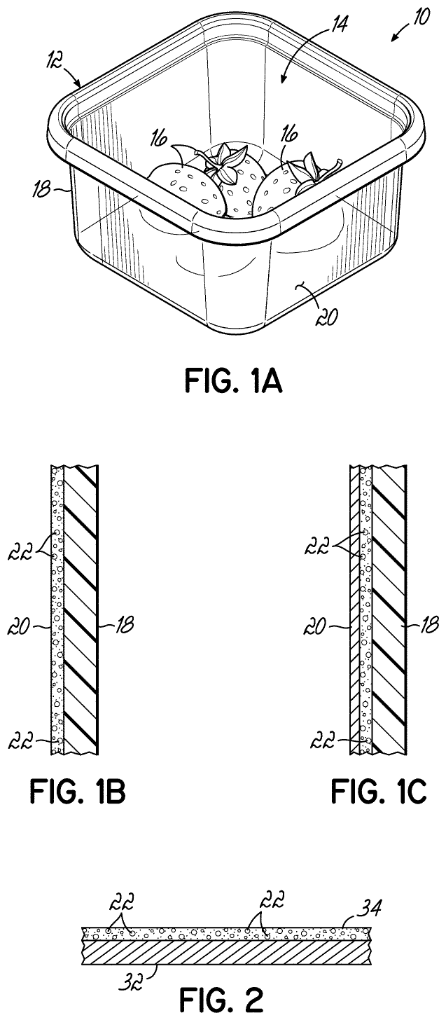

One aspect of the present invention, however, incorporates an anti-mold, anti-bacterial, and/or anti-virus substance directly into or onto packaging materials that come into direct contact with the food products themselves. Thus, an referring to FIGS. 1A-1C this aspect may provide a container 10 for packaging items, that container 10 including (1) a housing 12 defining an interior chamber 14 adapted to receive items 16, the housing 12 comprising at least one component 18 or having at least one material 20 disposed on the at least one component 18; and (2) an anti-mold, anti-bacterial, or anti-virus substance 22 incorporated in or on the at least one component 18 or in or on the at least one material 20.

In one embodiment, such an anti-mold, anti-bacterial, and/or anti-virus substance 22 may be food grade hydrogen peroxide. In various embodiments, the incorporation of the hydrogen peroxide directly into the packaging components may occur via incorporation into an existing adhesive, coating, varnish or surface treatment. The amount of hydrogen peroxide used may be limited to the amount sufficient for this purpose, and/or may be used at a recommended specific concentration. As will be recognized by those of ordinary skill in the art, anti-mold, anti-bacterial, and/or anti-virus substances other than hydrogen peroxide may be used.

In certain embodiments, the at least one component 18 of the housing 12 may be chosen from paper, film, or a polymer; the at least one material 20 may be chosen from an adhesive, a coating, a varnish, and a surface treatment; and the anti-mold, anti-bacterial, or anti-virus substance 22 may include hydrogen peroxide.

In further embodiments (as mentioned above), the anti-mold, anti-bacterial, or anti-virus substance 22 may be encapsulated, and the container 10 may include microcapsules containing the encapsulated anti-mold, anti-bacterial, or anti-virus substance.

In further embodiments, the at least one component 18 or the at least one material 20 having the anti-mold, anti-bacterial, or anti-virus substance 22 incorporated therein or thereon may be exposed to the outside of the housing 12. Alternatively, or additionally, the at least one component 18 or the at least one material 20 having the anti-mold, anti-bacterial, or anti-virus substance 22 incorporated therein or thereon may exposed to the interior chamber 14.

In a further embodiment, the at least one component 18 of the housing 12 may include first and second layers 24, 26 with the anti-mold, anti-bacterial, or anti-virus substance 22 being positioned between the first and second layers 24, 26. In a particular such embodiment, one of the first and second layer may be paper, and the other of the first and second layer may be a film.

Another aspect of the present invention may provide for the use of an anti-mold, anti-bacterial, or anti-virus agent that can be incorporated into the outside layers of labels and packaging materials. Thus, this aspect may provide a label 30 including (1) at least a first label layer 32 and a second label layer 34, the first label layer 32 being a facestock layer, and the second label layer 34 being chosen from an adhesive, an ink, a varnish, a coating, and a protective layer; and (2) an anti-mold, anti-bacterial, or anti-virus substance 22 incorporated in or on the first label layer or the second label layer.

In one embodiment, the substance 22 may be an anti-virus substance. And, in certain embodiments, the anti-mold, anti-bacterial, or anti-virus agent may be hydrogen peroxide. Based on available evidence that hydrogen peroxide is a proven killer of numerous viruses, the various aspects of the present invention are also very useful in that the anti-mold, anti-bacterial, or anti-virus substance—such as hydrogen peroxide—is incorporated into the surface coatings of labels and packages to reduce or eliminate the potential for spread of viruses from an infected individual by either direct contact with the package or an airborne transmission. In one embodiment, the hydrogen peroxide may be encapsulated (such as in microcapsules) and present on the outside layer of a label or a packaging material. When activated through various mechanisms such as handling and bursting of the microcapsules (e.g., due to pressure applied to the microcapsules by a hand grasping a container), the release of the hydrogen peroxide would inhibit, stop, or kill the virus directly on the surfaces. Other embodiments may include microencapsulation with time release technology.

In certain embodiments of the label, the facestock layer (e.g., first label layer 32) includes a material chosen from paper or film.

In a further embodiment, the first label layer 32 or the second label layer 34 having the anti-mold, anti-bacterial, or anti-virus substance incorporated therein or thereon may be a layer of a label that is exposed once the label is applied to an article.

In further embodiments (as mentioned above), the anti-mold, anti-bacterial, or anti-virus substance 22 may be encapsulated, and the label may include microcapsules containing the encapsulated anti-mold, anti-bacterial, or anti-virus substance.

In certain embodiments, then, the present invention would introduce a microencapsulated hydrogen peroxide into the surface coatings of labels and packaging and utilize sustained and/or time release features thus delaying the useful effect until the labeled product or package is in the marketplace.

Advantages of the present invention include, but are not limited to, that once incorporated into the packaging components, the hydrogen peroxide functions as a component of the packaging to seamlessly treat and kill yeasts, fungi, bacteria, viruses, and mold spores without the attention of the consumer.

Further, one manner in which the aspects of the present invention differ from prior art is that the hydrogen peroxide is not introduced directly into the food product in the manufacturing process but is incorporated into the packaging of the product either by blending into a coating and/or directly into the packaging substrate itself. As described above, prior art patents—such as U.S. Pat. No. 5,328,706—utilize an aqueous solution of hydrogen peroxide and is integrated into semi-viscous and viscous food products in the processing procedure for reducing microbial activity. Further, the decomposition of the peroxide in that prior art patent is regulated by a protein derived enzyme and is monitored to eliminate the presence of peroxide in the finished food product. The present invention differs in that the hydrogen peroxide is not introduced directly into the food in the processing step only into/onto the food's packaging with the intent of creating a continuous antimicrobial effect on the food product over its shelf life.

Additional aspects of the present invention may be seen in the following examples.

### EXAMPLE 1

Testing of aspects of the present invention for use in a direct food contact application as a mold inhibitor was conducted with the use of a lab grade hydrogen peroxide (32%) which was diluted with distilled water utilizing a mixing apparatus at various percentages and then incorporated into a water-based direct food contact coating (utilizing a mixing apparatus) again at various dilution percentages. The coating(s) were then tested by being applied to the surface of a food grade 40 lb. bleached butcher paper via both flexographic printing and also Mayer rod draw-downs, which were then cut to fit food storage containers or cut and fashioned into small storage bags. The material substrate used in this trial was an unsupported food grade paper commonly used in food markets (but could have been many different label or packaging constructions depending on the end use requirements).

Fresh strawberries were placed into the containers and the bags, and were in direct contact with the modified coating. (Additional containers and bags were made up of the same paper substrate but with the coating in its non-modified state as a control.)

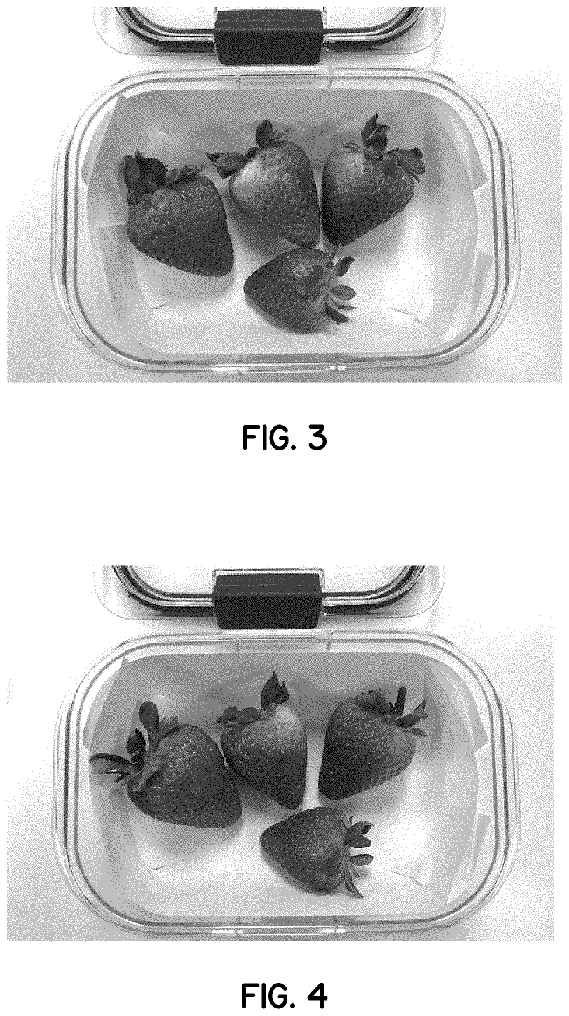

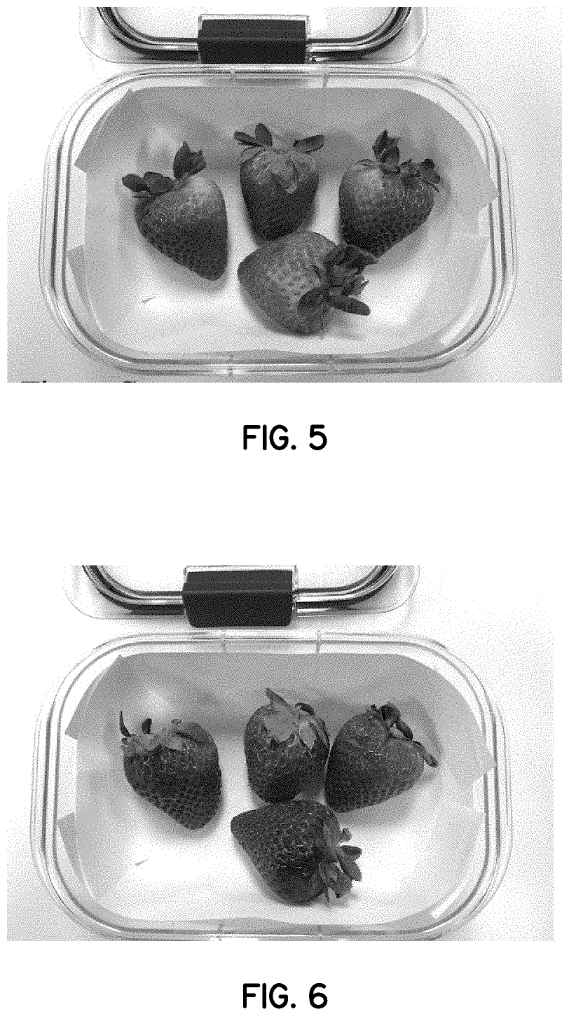

Results can be seen in FIGS. 3-6, where FIG. 3 shows an example of the fresh fruit in the container with the hydrogen peroxide-modified coating substrate on day 1 of the testing; FIG. 4 shows the sample of FIG. 3 on day 4 with little to no noticeable degradation of the fruit; FIG. 5 is an example of the container with the standard coated substrate (i.e., without hydrogen peroxide) on day 1; and FIG. 6 is the same as FIG. 5 but on day 4. As can be seen in FIG. 6, there has been degradation of the fruit and development of mold.

The testing was conducted at room temperature (RT) conditions and also in a refrigerated environment at 38° F./40% RH. Similar results were witnessed in both conditions in that the strawberries that were placed onto the hydrogen peroxide treated paper exhibited far less ripening and no mold formation as compared to the fruit on the untreated paper that ripened rapidly particularly at RT conditions and exhibited mold growth.

The percentage of hydrogen peroxide in the particular testing of the Figures was approximately 3% by volume. However, the percentage of hydrogen peroxide could be used in the range of 0.5% to 20%, depending on the application.

### EXAMPLE 2

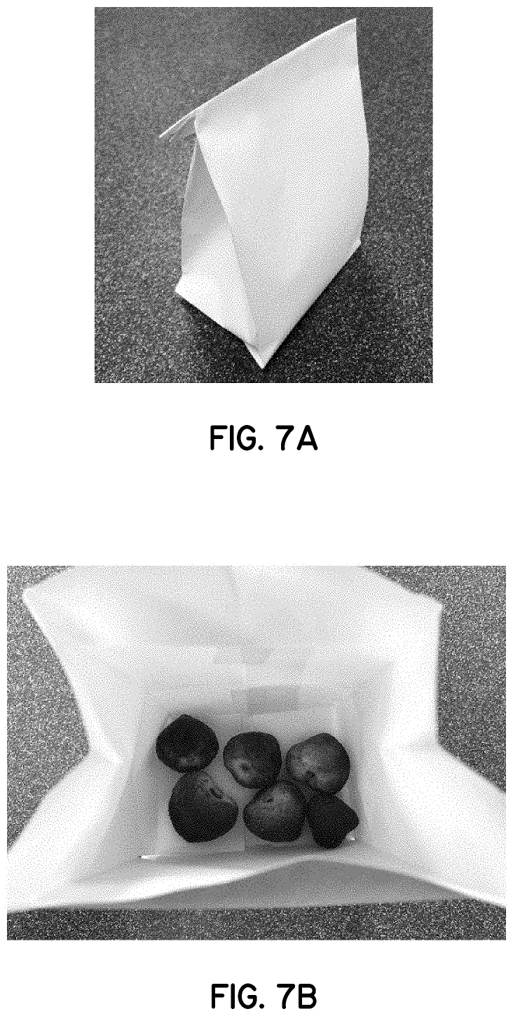

Referring to FIGS. 7A and 7B, a bag version of a container is shown. This bag was constructed by the addition of hydrogen peroxide into a pressure sensitive laminating adhesive again via a mixing apparatus (as was done in Example 1) to an approximate 3% by volume final percentage, which was used to bond two layers of food grade paper together and then formed into a bag. This approach would create a barrier between the chemical and the food and rely on factors such as migration and/or outgassing to permeate into direct contact with the food product. (Additionally, the laminated construction could incorporate a film substrate as the outer layer in conjunction with an inner paper substrate thus forming a more durable barrier that would thus protect the outside of the bag or package and help to focus the chemicals effect on the food contents. Further, the bag construction is not limited to a laminated version and could utilize the single layer paper version detailed above that was used in the storage container.)

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed is:

1. A container for packaging items, comprising:
a housing defining an interior chamber adapted to receive items, the housing comprising at least one component or having at least one material disposed on at least one component; and
an anti-mold, anti-bacterial, or anti-virus substance incorporated in or on said at least one component or in or on said at least one material.

2. The container of claim 1, wherein said at least one component is chosen from paper, film, or a polymer.

3. The container of claim 1, wherein said at least one material is chosen from an adhesive, a coating, a varnish, and a surface treatment.

4. The container of claim 1, wherein the anti-mold, anti-bacterial, or anti-virus substance includes hydrogen peroxide.

5. The container of claim 1, wherein said anti-mold, anti-bacterial, or anti-virus substance is encapsulated.

6. The container of claim 5, further comprising microcapsules containing said encapsulated anti-mold, anti-bacterial, or anti-virus substance.

7. The container of claim 1, wherein said items include food.

8. The container of claim 1, wherein said at least one component or said at least one material having said anti-mold, anti-bacterial, or anti-virus substance incorporated therein or thereon is exposed to the outside of the housing.

9. The container of claim 1, wherein said at least one component or said at least one material having said anti-mold, anti-bacterial, or anti-virus substance incorporated therein or thereon is exposed to the interior chamber.

10. The container of claim 1, the at least one component of the housing further comprising first and second layers with said anti-mold, anti-bacterial, or anti-virus substance being positioned between said first and second layers.

11. The container of claim 11, wherein one of the first and second layer is paper, and the other of said first and second layer is a film.

12. The container of claim 4, wherein the hydrogen peroxide incorporated in or on said at least one component or in or on said at least one material is present in a range of 0.5% to 20% by volume.

13. The container of claim 12, wherein the hydrogen peroxide is present in an amount of 3% by volume.

14. A label comprising:
at least a first label layer and a second label layer, the first label layer being a facestock layer, and the second label layer being chosen from an adhesive, an ink, a varnish, a coating, and a protective layer; and
an anti-mold, anti-bacterial, or anti-virus substance incorporated in or on said first label layer or said second label layer.

15. The label of claim 14, wherein said facestock layer includes a material chosen from paper or film.

16. The label of claim 14, wherein said first label layer or said second label layer having said anti-mold, anti-bacterial, or anti-virus substance incorporated therein or thereon is a layer of a label that is exposed once the label is applied to an article.

17. The label of claim 14, wherein said anti-mold, anti-bacterial, or anti-virus substance includes hydrogen peroxide.

18. The label of claim 14, wherein said anti-mold, anti-bacterial, or anti-virus substance is encapsulated.

19. The label of claim 18, further comprising microcapsules containing said encapsulated anti-mold, anti-bacterial, or anti-virus substance.

20. The label of claim 17, wherein the hydrogen peroxide incorporated in or on said first label layer or said second label layer is present in a range of 0.5% to 20% by volume.
